(19) United States
(12) Patent Application Publication
(10) Pub. No.: US 2007/0080577 A1
(43) Pub. Date: Apr. 12, 2007

(54) Nipple for bicycle and motorcycle wheels

(76) Inventor: Moreno Fioravanti, Lomagna (IT)

Correspondence Address: RATNERPRESTIA, P O BOX 980, VALLEY FORGE, PA, 19482-0980, US

(21) Appl. No.: 10/556,882

(22) PCT Filed: May 21, 2004
(86) PCT No.: PCT/IT04/00293

§ 371 Date: Nov. 15, 2005

(30) Foreign Application Priority Data
May 22, 2003 (IT) BO2003A000316

(51) Int. Cl. B60B 1/00

(52) U.S. Cl. 301/104

(57) ABSTRACT

A nipple for bicycle and motorcycle wheels, including a head for attachment to a rim of the wheel and a shank for connection to the distal extremity of a corresponding spoke, and the shank has an externally threaded portion which can engage in a female thread provided in the extremity of the spoke.

### TECHNICAL SCOPE

This invention relates to a nipple for bicycle and motorcycle wheels.

### TECHNOLOGICAL BACKGROUND

In the sector of the manufacture of bicycles and motorcycles the need has arisen for the manufacture of wheels of ever-increasing performance which are particularly reliable, specifically as regards strength, rigidity, aerodynamic behaviour and lightness. This requires that some fundamental parameters such as, among others, the transverse cross-section of the spokes and, as a consequence, the nipples connecting these to the rim, must be overdimensioned at the design stage. However this option often gives rise to an inevitable increase in the overall weight of the wheel and its cost, thus comprising quality of performance and competitiveness.

### DESCRIPTION OF THE INVENTION

The technical purpose of this invention is to overcome the aforesaid disadvantages, providing a nipple for bicycle and motorcycle wheels which makes it possible to fit spokes of large cross-section but small weight and dimensions.

Within the scope of this technical purpose one object of this invention is the provision of a nipple for bicycle and motorcycle wheels having high-grade mechanical properties and capable of ensuring secure and reliable attachment of the spoke to the rim.

Another object of this invention is to provide a spoke for the wheels of bicycles and motorcycles which can be manufactured using conventional production technology and equipment.

Yet another object of this invention is to fulfil the abovementioned purpose through a simple structure which is relatively easy to implement in practice, safe in use and effective in functioning, and of relatively low cost.

This purpose and these objects are achieved through this spoke for bicycle and motorcycle wheels which comprises a head for attachment to the wheel's rim and a shank for attachment to the distal extremity of a corresponding spoke, characterised in that the said shank has an externally threaded portion which can engage a female thread provided in the said extremity of the spoke.

### BRIEF DESCRIPTION OF THE DRAWINGS

Other advantages and characteristics of the present invention will become clear from the following detailed description which is given with reference to the appended drawings which are provided purely by way of non-limiting example and in which:

FIG. 1 illustrates in detail a lateral view in elevation and in partial cross-section of a bicycle wheel provided with a nipple according to the invention attached to a corresponding spoke,

FIG. 2 shows a plan view of the nipple in FIG. 1,

FIG. 3 shows a view in lateral elevation of a first alternative embodiment of the nipple according to the invention,

FIG. 4 illustrates a plan view of the nipple in FIG. 3,

FIG. 5 shows a view in lateral elevation of a second alternative embodiment of the nipple according to the invention,

FIG. 6 shows a plan view of the nipple in FIG. 5,

FIG. 7 illustrates a transverse cross-section of the same nipple along the plane VII-VII in FIG. 5,

FIG. 8 shows a view in lateral elevation of a third alternative embodiment of the nipple,

FIG. 9 shows a plan view of the nipple in FIG. 8,

FIG. 10 shows a view in lateral elevation of a fourth alternative embodiment of the nipple according to the invention,

FIG. 11 shows a plan view of the nipple in FIG. 10,

FIG. 12 shows a view in lateral elevation of a fifth alternative embodiment of the nipple,

FIG. 13 shows a plan view of the nipple in FIG. 12.

### PREFERRED MANNER OF IMPLEMENTING THE INVENTION

In the embodiments which follow individual features shown in relation to specific examples may in fact be interchanged with other different features present in other embodiments.

Also it should be pointed out that everything which proves to be already known in the course of the procedure for obtaining the patent is not intended to be claimed and is removed from the claims.

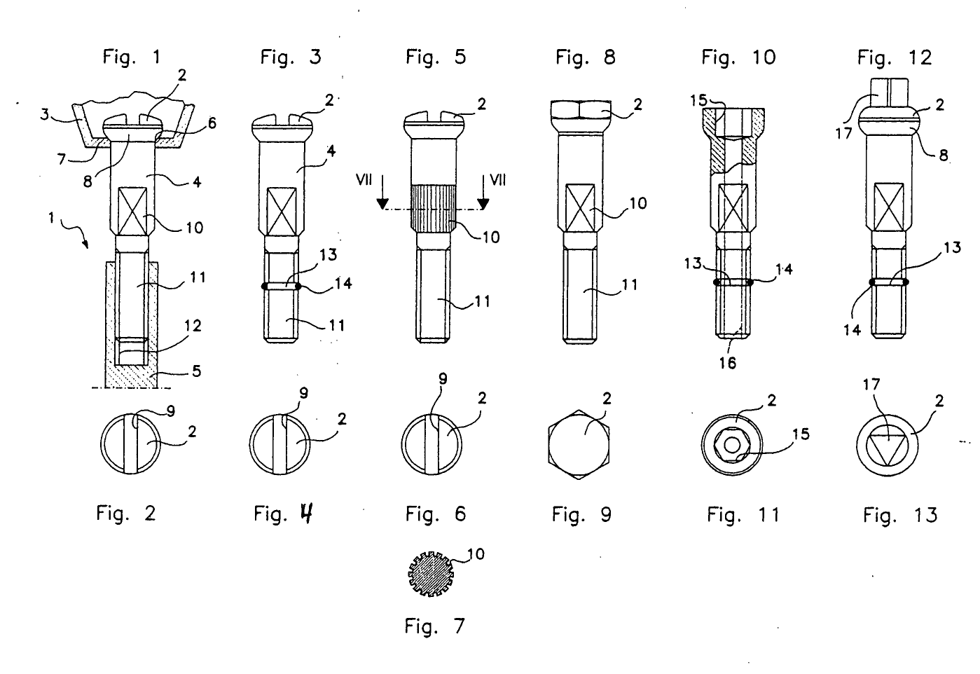

With particular reference to FIG. 1, 1 indicates as a whole a nipple for bicycle and motorcycle wheels according to the invention.

The nipple comprises a head 2 for attachment to the rim 3 of the wheel, extending through a shank 4 which can be connected to the distal terminal extremity of a corresponding spoke 5. Shank 4 is engaged in a hole 6 provided in inner wall 7 of rim 3; when spoke 5 is fitted, head 2 bears against inner wall 7.

Head 2 is of a substantially discoidal shape and forms beneath an annular surface 8, which is preferably convex, which bears against the edge of hole 6. Head 2 has above a straight diametral notch 9 (FIG. 2) of substantially rectangular transverse cross-section for the insertion of a suitable tool for securing the nipple to spoke 5 and rim 3.

Shank 4 of the nipple has a substantially cylindrical shape and is provided, preferably in its middle part, with means 10 for adjusting the assembly tension of spoke 5 once the latter has been attached to the nipple and hub of the wheel at the opposite ends respectively.

According to the invention shank 4 has an externally threaded portion 11 which can engage a corresponding female thread 12 provided in the distal extremity of spoke 5 so as to form a removable rigid connection; the axis of symmetry of female thread 12 coincides with the longitudinal axis of symmetry of spoke 5.

Threaded portion 11 is terminal and preferably extends from the extremity of shank 4 to substantially its middle. The relative immobilisation between threaded portion 11 and female thread 12 provided at the extremity of spoke 5 is achieved, for example, by the application of suitable high quality quick-setting adhesives, or other wholly equivalent means.

Means 10 for adjusting the assembly tension of spoke 5 preferably comprise a pair of diametrically opposed lateral plane parallel flats provided on the lateral surface of shank 4 in its central portion; these flats can be used to accurately screw or unscrew threaded portion 11 into and out of female thread 12, with nipple 1 and spoke 5 already assembled with rim 3 and the hub, so as to achieve optimum balancing of the wheel.

Conveniently shank 4 of the nipple may be constructed to be hollow, in such a way as to achieve substantial and advantageous lightness.

The method for use of the nipple according to the invention is intuitive. On assembly shank 4 is inserted into hole 6 and threaded portion 11 engages female thread 12 in spoke 5. By using a suitable tool threaded portion 11 is progressively screwed into female thread 12 until the annular surface 8 of head 2 abuts against inner wall 7 of rim 3, particularly against the edge of hole 6.

Once spoke 5 has been fitted, its tension can be adjusted with extreme accuracy by acting on adjustment means 10, thus achieving optimum balancing of the wheel.

This is how the invention achieves the stated objectives.

The nipple according to the invention may be constructed from a great variety of metal alloys according to the mechanical properties and weight which it is intended to obtain. Steel, stainless steel, brass and aluminium alloys may In fact be used.

The nipple can be manufactured using conventional production technologies, thus using known tools which are already available. It may be turned, forged, or cold or hot moulded.

Many surface finishing operations of a functional or aesthetic type may then be carried out on the nipple. Mention may be made, among others, of chromium-plating, zinc-plating, anodic oxidation, painting and electro-colouring.

The invention conceived in this way is susceptible of many modifications and variants all of which fall within the scope of the inventive concept.

A first alternative embodiment of the nipple according to the invention is illustrated in FIGS. 3 and 4. This has a terminal threaded portion 11 bearing an annular groove 13 for fitting a ring 14 which has a self-locking effect, through which it is possible to obtain secure fixing within female thread 12 at the extremity of spoke 5. Self-locking ring 14 is preferably manufactured of synthetic material.

FIG. 5 shows a second alternative embodiment of the nipple according to the Invention. In this nipple means 10 for adjustment of the spoke assembly tension comprise, substantially at the central portion of shank 4, a cylindrical length which is longitudinally knurled on its lateral surface (the transverse cross-section of which is illustrated in FIG. 7) in such a way that accurate relative screwing and unscrewing of the nipple into and out of spoke 5 can be carried out manually or using a suitable tool. It is thus possible to effect fine and accurate adjustment of the assembly tension of the spoke between the hub and rim 3.

A third alternative embodiment of the nipple (FIGS. 8, 9) has a head 2 of hexagonal shape for screwing and unscrewing a threaded portion 11 into and out of corresponding female thread 12 using a suitable tool; this proves particularly advantageous in applications where a high tightening torque is required.

FIGS. 10 and 11 relate to a fourth alternative embodiment of the nipple, which has a substantially discoidal head 2 with a recess 15 of hexagonal cross-section adjusted using a suitable tool, for applications where working space is limited. Shank 4 of the nipple has a substantially cylindrical through longitudinal cavity 16 in order to lighten it, while terminal threaded portion 11 has annular groove 13 for fitting self-locking ring 14 or other equivalent locking means within female thread 12.

In a fifth alternative embodiment illustrated in FIGS. 12 and 13, discoidal head 2 of the nipple is extended above by a prismatic appendage 17 having a triangular cross-section; appendage 17 makes it possible for the nipple to be screwed and unscrewed in the extremity of spoke 5 using a suitable tool in applications where working space is limited.

All details may be replaced by other technical equivalents.

In practice the materials used, and shapes and dimensions, may be of any kind according to requirements without thereby going beyond the scope of protection of the following claims.

1. A nipple for bicycle and motorcycle wheels, comprising: a head for attachment to a rim of the wheel and a shank for connection to the distal extremity of a corresponding spoke, and the shank has an externally threaded portion which can engage in a female thread provided in the extremity of the spoke.

2. The nipple according to claim 1, wherein the threaded portion extends substantially from the extremity to the middle of the shank.

3. The nipple according to claims 1, wherein the threaded portion has an annular groove for the fitting of a ring with a self-locking effect for permanent fixture in the female thread.

4. The nipple according to claim 3, wherein the ring is constructed of synthetic material.

5. The nipple according to claim 1, wherein the head defines an annular abutment surface on an inner wall of the rim.

6. The nipple according to claim 1, wherein the shank is provided, substantially in its middle portion, with means for adjusting the assembly tension of the spoke.

7. The nipple according to claim 6, wherein the adjustment means includes a pair of diametrically opposite parallel lateral flats.

8. The nipple according to claim 6, wherein the adjustment means includes a substantially cylindrical length which is longitudinally knurled along its lateral surface.

9. The nipple according to claim 1, further comprising a longitudinal cylindrical cavity to lighten the nipple.

10. The nipple according to claim 1, wherein the head is substantially discoidal and has a diametral notch for screwing and unscrewing the threaded terminal portion into and out of the said female thread.

11. The nipple according to claim 1, wherein the head has a substantially hexagonal shape for screwing and unscrewing the threaded terminal portion into and out of the female thread.

12. The nipple according to claim 1, wherein the head is substantially discoidal and has a recess of hexagonal cross-section for screwing and unscrewing the threaded terminal portion into and out of the female thread.

13. The nipple according to claim 1, wherein the head is substantially discoidal and is extended above by a prismatic appendage and is of triangular cross-section for screwing and unscrewing the threaded terminal portion into and out of the female thread.

14. (canceled)

15. The nipple according to claim 2 wherein the threaded portion has an annular groove for the fitting of a ring with a self-locking effect for permanent fixture in the female thread.

16. The nipple according to claim 2, wherein the head defines an annular abutment surface on an inner wall of the rim.

17. The nipple according to claim 3, wherein the head defines an annular abutment surface on an inner wall of the rim.

18. The nipple according to claim 4, wherein the head defines an annular abutment surface on an inner wall of the rim.

19. The nipple according to claim 2, wherein the shank is provided, substantially in its middle portion, with means for adjusting the assembly tension of the spoke.

20. The nipple according to claim 3, wherein the shank is provided, substantially in its middle portion, with means for adjusting the assembly tension of the spoke.

21. The nipple according to claim 4, wherein the shank is provided, substantially in its middle portion, with means for adjusting the assembly tension of the spoke.
